(19) United States
(12) Patent Application Publication
(10) Pub. No.: US 2024/0172297 A1
(43) Pub. Date: May 23, 2024

(54) CAPABILITY OR SERVICE INDICATION OVER RANDOM ACCESS CHANNEL

(71) Applicant: QUALCOMM Incorporated, San Diego, CA (US)

(72) Inventors: Ruiming ZHENG, Beijing (CN); Linhai HE, San Diego, CA (US); Peng CHENG, Beijing (CN); Jianhua LIU, Beijing (CN); Jing LEI, San Diego, CA (US)

(21) Appl. No.: 18/551,842

(22) PCT Filed: May 5, 2022
(86) PCT No.: PCT/CN2022/090884

§ 371 Date: Sep. 21, 2023

(30) Foreign Application Priority Data
May 5, 2021 (WO) PCT/CN2021/091821

(51) Int. Cl. H04W 74/0833; H04W 8/24

(52) U.S. Cl. CPC H04W 74/0833; H04W 8/24

(57) ABSTRACT

Certain aspects of the present disclosure provide techniques for indicating a user equipment capability or service. A method that may be performed by a user equipment (UE) includes transmitting, to a network entity, an indication of at least one of a capability of the UE or a service for the UE in a random access channel (RACH) procedure and communicating with the network entity in accordance with the indication.

### CROSS-REFERENCE TO RELATED APPLICATION

This application claims benefit of and priority to International Application No. PCT/CN2021/091821, filed May 5, 2021, which is herein incorporated by reference in its entirety for all applicable purposes.

### BACKGROUND

### Field of the Disclosure

Aspects of the present disclosure relate to wireless communications, and more particularly, to techniques for indicating a user equipment capability or service.

### Description of Related Art

Wireless communication systems are widely deployed to provide various telecommunication services such as telephony, video, data, messaging, broadcasts, etc. These wireless communication systems may employ multiple-access technologies capable of supporting communication with multiple users by sharing available system resources (e.g., bandwidth, transmit power, etc.). Examples of such multiple-access systems include 3rd Generation Partnership Project (3GPP) Long Term Evolution (LTE) systems, LTE Advanced (LTE-A) systems, code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems, to name a few.

These multiple access technologies have been adopted in various telecommunication standards to provide a common protocol that enables different wireless devices to communicate on a municipal, national, regional, and even global level. New radio (e.g., 5G NR) is an example of an emerging telecommunication standard. NR is a set of enhancements to the LTE mobile standard promulgated by 3GPP. NR is designed to better support mobile broadband Internet access by improving spectral efficiency, lowering costs, improving services, making use of new spectrum, and better integrating with other open standards using OFDMA with a cyclic prefix (CP) on the downlink (DL) and on the uplink (UL). To these ends, NR supports beamforming, multiple-input multiple-output (MIMO) antenna technology, and carrier aggregation.

However, as the demand for mobile broadband access continues to increase, there exists a need for further improvements in NR and LTE technology. These improvements should be applicable to other multi-access technologies and the telecommunication standards that employ these technologies.

### SUMMARY

The systems, methods, and devices of the disclosure each have several aspects, no single one of which is solely responsible for its desirable attributes. After considering this discussion, and particularly after reading the section entitled “Detailed Description” one will understand how the features of this disclosure provide desirable wireless communication performance, such as desirable data rates, spectral efficiency, and/or latencies.

Certain aspects of the subject matter described in this disclosure can be implemented in a method for wireless communication by a user equipment (UE). The method generally includes transmitting, to a network entity in a random access channel (RACH) procedure, an indication of at least one of a capability of the UE or a service for the UE and communicating with the network entity in accordance with the indication.

Certain aspects of the subject matter described in this disclosure can be implemented in a method for wireless communication by a network entity. The method generally includes receiving, from a UE in a RACH procedure, an indication of at least one of a capability of the UE or a service for the UE and communicating with the UE in accordance with the indication.

Certain aspects of the subject matter described in this disclosure can be implemented in an apparatus for wireless communication. The apparatus generally includes a memory and a processor coupled to the memory. The processor is capable of being configured to transmit, to a network entity in a random access channel (RACH) procedure, an indication of at least one of a capability of the UE or a service for the UE, and communicate with the network entity in accordance with the indication.

Certain aspects of the subject matter described in this disclosure can be implemented in an apparatus for wireless communication. The apparatus generally includes a memory and a processor coupled to the memory. The processor is capable of being configured to receive, from a user equipment (UE) in a random access channel (RACH) procedure, an indication of at least one of a capability of the UE or a service for the UE, and communicate with the UE in accordance with the indication.

Certain aspects of the subject matter described in this disclosure can be implemented in an apparatus for wireless communication. The apparatus generally includes means for transmitting, to a network entity in a random access channel (RACH) procedure, an indication of at least one of a capability of the UE or a service for the UE; and means for communicating with the network entity in accordance with the indication.

Certain aspects of the subject matter described in this disclosure can be implemented in an apparatus for wireless communication. The apparatus generally includes means for receiving, from a user equipment (UE) in a random access channel (RACH) procedure, an indication of at least one of a capability of the UE or a service for the UE; and means for communicating with the UE in accordance with the indication.

Certain aspects of the subject matter described in this disclosure can be implemented in a computer-readable medium having instructions stored thereon for transmitting, to a network entity in a random access channel (RACH) procedure, an indication of at least one of a capability of the UE or a service for the UE; and communicating with the network entity in accordance with the indication.

Certain aspects of the subject matter described in this disclosure can be implemented in a computer-readable medium having instructions stored thereon for receiving, from a user equipment (UE) in a random access channel (RACH) procedure, an indication of at least one of a capability of the UE or a service for the UE; and communicating with the UE in accordance with the indication.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the drawings. It is to be noted, however, that the appended drawings illustrate only certain aspects of this disclosure and the description may admit to other equally effective aspects.

FIG. 1 is a block diagram conceptually illustrating an example wireless communication network, in accordance with certain aspects of the present disclosure.

FIG. 2 is a block diagram conceptually illustrating a design of an example a base station (BS) and user equipment (UE), in accordance with certain aspects of the present disclosure.

FIG. 3 is an example frame format for certain wireless communication systems (e.g., new radio (NR)), in accordance with certain aspects of the present disclosure.

FIG. 4 is a signaling flow diagram illustrating an example four-step random access channel (RACH) procedure, in accordance with certain aspects of the present disclosure.

FIG. 5A is a signaling flow diagram illustrating an example of a two-step RACH procedure, where contention resolution is successful at the BS, in accordance with certain aspects of the present disclosure.

FIG. 5B is a signaling flow diagram illustrating an example of a two-step RACH procedure, where contention resolution is unsuccessful at the BS, in accordance with certain aspects of the present disclosure.

FIG. 6 is a flow diagram illustrating example operations for wireless communication by a UE, in accordance with certain aspects of the present disclosure.

FIG. 7 is a flow diagram illustrating example operations for wireless communication by a network entity, in accordance with certain aspects of the present disclosure.

FIGS. 8A-8C are diagrams illustrating examples of a medium access control (MAC) control element (CE) and corresponding subheader, in accordance with certain aspects of the present disclosure.

FIG. 9A is a signaling flow diagram illustrating example signaling for indicating one or more UE capabilities or services in a two-step RACH procedure, in accordance with aspects of the present disclosure.

FIG. 9B is a signaling flow diagram illustrating example signaling for indicating one or more UE capabilities or services in a four-step RACH procedure, in accordance with aspects of the present disclosure.

FIG. 10 illustrates a communications device (e.g., a UE) that may include various components configured to perform operations for the techniques disclosed herein in accordance with aspects of the present disclosure.

FIG. 11 illustrates a communications device (e.g., a BS) that may include various components configured to perform operations for the techniques disclosed herein in accordance with aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Aspects of the present disclosure provide apparatus, methods, processing systems, and computer readable mediums for indicating a capability and/or service over a random access channel (RACH).

Certain wireless communication systems (e.g., a Evolved Universal Terrestrial Radio Access (E-UTRA) system and/or New Radio (NR) system) may enable access to network services using a physical layer configured for very low power consumption and low complexity, which may be beneficial for Internet-of-Things (IOT) devices operating on battery power. In various scenarios, a user equipment (UE) may communicate with a network entity (such as a base station) via a random access channel (RACH) procedure. For example, the UE may use a RACH procedure for initial radio resource control (RRC) connection setup, RRC connection re-establishment, a handover scenario, a scheduling request failure, beam recovery, downlink or uplink data arrival, etc. A radio access network may provide RACH partitioning for certain UE capabilities (such as capabilities for narrowband communications, enhanced mobile broadband (eMBB), ultra-reliable low-latency communications (URLLC), and/or coverage enhancement) and/or services (such as a small data transmission and/or radio access network (RAN) slicing). When RACH resources are partitioned for too many capabilities and/or services, there may be loss of efficiency, which may cause resource fragmentation and/or losses in trunking gains.

Aspects of the present disclosure provide techniques and apparatus for indicating a capability and/or service over a RACH. The indication described herein may facilitate the network to dynamically respond to the capabilities of a UE and/or a service indicated by the UE. For example, an indication of a UE capability or service may enable the network to prioritize the response time for ultra-low latency or prioritized radio access network (RAN) slicing. In certain cases, the indication of the UE capability or service may inform the network of a specific RACH configuration, such as power ramping step, a backoff scaling factor, or a response window assigned to the UE. In certain cases, the indication of the UE capability or service may enable the network to assign a dedicated resource for the physical uplink shared channel (PUSCH) payload or inform the network that the UE is using the dedicated resource for the PUSCH payload.

The indication of the UE capability or service may facilitate desirable wireless communication performance, such as desirable data rates, spectral efficiency, and/or latencies. For example, the indication of the UE capability or service may enable a dynamic response from the network, which may facilitate desirable resource and/or preamble partitioning. The indication of the UE capability or service may enable desirable performance for certain scenarios, such as dedicated resources for small data transmissions, shorter response windows for low latency or URLLC services, and/or a specific bandwidth configuration for narrowband UEs.

The following description provides examples of random access in communication systems. Changes may be made in the function and arrangement of elements discussed without departing from the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the disclosure is intended to cover such an apparatus or method which is practiced using other structure, functionality, or structure and functionality in addition to, or other than, the various aspects of the disclosure set forth herein. It should be understood that any aspect of the disclosure disclosed herein may be embodied by one or more elements of a claim. The word “exemplary” is used herein to mean “serving as an example, instance, or illustration.” Any aspect described herein as “exemplary” is not necessarily to be construed as preferred or advantageous over other aspects.

In general, any number of wireless networks may be deployed in a given geographic area. Each wireless network may support a particular radio access technology (RAT) and may operate on one or more frequencies. A RAT may also be referred to as a radio technology, an air interface, etc. A frequency may also be referred to as a carrier, a subcarrier, a frequency channel, a tone, a subband, etc. Each frequency may support a single RAT in a given geographic area in order to avoid interference between wireless networks of different RATs.

The techniques described herein may be used for various wireless networks and radio technologies. While aspects may be described herein using terminology commonly associated with 3G, 4G, and/or new radio (e.g., 5G NR) wireless technologies, aspects of the present disclosure can be applied in other generation-based communication systems.

NR access may support various wireless communication services, such as enhanced mobile broadband (eMBB) targeting wide bandwidth, millimeter wave mmW, massive machine type communications MTC (mMTC) targeting non-backward compatible MTC techniques, and/or mission critical targeting ultra-reliable low-latency communications (URLLC). These services may include latency and reliability requirements. These services may also have different transmission time intervals (TTI) to meet respective quality of service (QOS) requirements. In addition, these services may co-exist in the same subframe.

The electromagnetic spectrum is often subdivided, based on frequency/wavelength, into various classes, bands, channels, etc. In 5G NR two initial operating bands have been identified as frequency range designations FR1 (410 MHz-7.125 GHZ) and FR2 (24.25 GHz-52.6 GHZ). The frequencies between FR1 and FR2 are often referred to as mid-band frequencies. Although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHZ, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band.

NR supports beamforming and beam direction may be dynamically configured. MIMO transmissions with precoding may also be supported. MIMO configurations in the DL may support up to 8 transmit antennas with multi-layer DL transmissions up to 8 streams and up to 2 streams per UE. Multi-layer transmissions with up to 2 streams per UE may be supported. Aggregation of multiple cells may be supported with up to 8 serving cells.

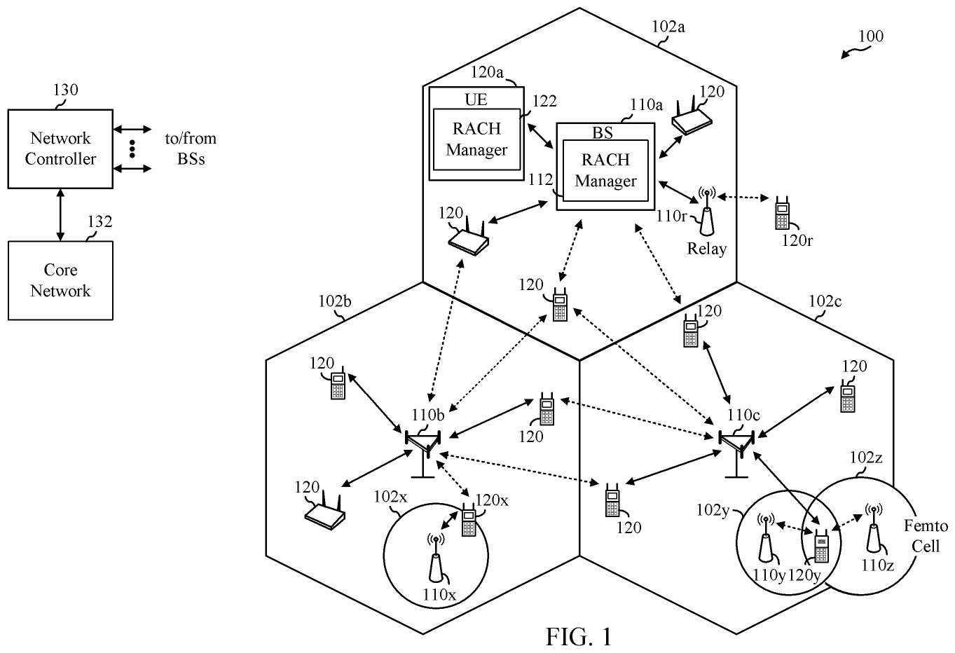

FIG. 1 illustrates an example wireless communication network 100 in which aspects of the present disclosure may be performed. For example, the wireless communication network 100 may be an NR system (e.g., a 5G NR network). As shown in FIG. 1, the wireless communication network 100 may be in communication with a core network 132. The core network 132 may in communication with one or more base station (BSs) 110a-z (each also individually referred to herein as BS 110 or collectively as BSs 110) and/or user equipment (UE) 120a-y (each also individually referred to herein as UE 120 or collectively as UEs 120) in the wireless communication network 100 via one or more interfaces.

As shown in FIG. 1, the BS 110a includes a RACH manager 112 that receives an indication of a UE capability or service and communicates with a UE in accordance with the indication, in accordance with aspects of the present disclosure. The UE 120a includes a RACH manager 122 that transmits an indication of a UE capability or service and communicates with a BS in accordance with the indication, in accordance with aspects of the present disclosure.

A BS 110 may provide communication coverage for a particular geographic area, sometimes referred to as a “cell”, which may be stationary or may move according to the location of a mobile BS 110. In some examples, the BSs 110 may be interconnected to one another and/or to one or more other BSs or network nodes (not shown) in wireless communication network 100 through various types of backhaul interfaces (e.g., a direct physical connection, a wireless connection, a virtual network, or the like) using any suitable transport network. In the example shown in FIG. 1, the BSs 110a, 110b and 110c may be macro BSs for the macro cells 102a, 102b and 102c, respectively. The BS 110x may be a pico BS for a pico cell 102x. The BSs 110y and 110z may be femto BSs for the femto cells 102y and 102z, respectively. A BS may support one or multiple cells.

The BSs 110 communicate with UEs 120 in the wireless communication network 100. The UEs 120 (e.g., 120x, 120y, etc.) may be dispersed throughout the wireless communication network 100, and each UE 120 may be stationary or mobile. Wireless communication network 100 may also include relay stations (e.g., relay station 110r), also referred to as relays or the like, that receive a transmission of data and/or other information from an upstream station (e.g., a BS 110a or a UE 120r) and sends a transmission of the data and/or other information to a downstream station (e.g., a UE 120 or a BS 110), or that relays transmissions between UEs 120, to facilitate communication between devices.

A network controller 130 may be in communication with a set of BSs 110 and provide coordination and control for these BSs 110 (e.g., via a backhaul). In certain cases, the network controller 130 may include a centralized unit (CU) and/or a distributed unit (DU), for example, in a 5G NR system. In aspects, the network controller 130 may be in communication with a core network 132 (e.g., a 5G Core Network (5GC)), which provides various network functions such as Access and Mobility Management, Session Management, User Plane Function, Policy Control Function, Authentication Server Function, Unified Data Management, Application Function, Network Exposure Function, Network Repository Function, Network Slice Selection Function, etc.

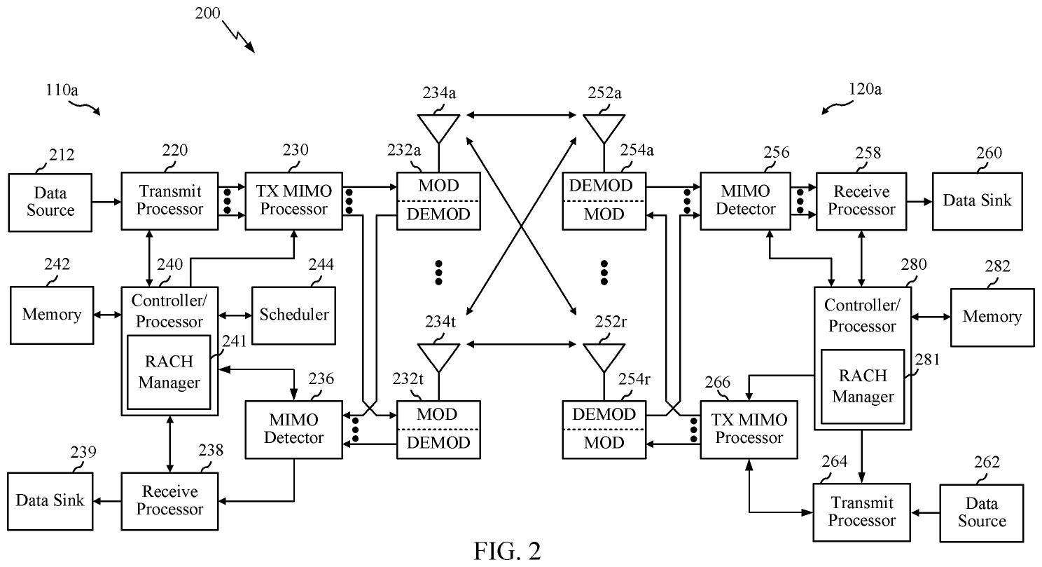

FIG. 2 illustrates example components of BS 110a and UE 120a (e.g., the wireless communication network 100 of FIG. 1), which may be used to implement aspects of the present disclosure.

At the BS 110a, a transmit processor 220 may receive data from a data source 212 and control information from a controller/processor 240. The control information may be for the physical broadcast channel (PBCH), physical control format indicator channel (PCFICH), physical hybrid ARQ indicator channel (PHICH), physical downlink control channel (PDCCH), group common PDCCH (GC PDCCH), etc. The data may be for the physical downlink shared channel (PDSCH), etc. A medium access control (MAC)-control element (MAC-CE) is a MAC layer communication structure that may be used for control command exchange between wireless nodes. The MAC-CE may be carried in a shared channel such as a physical downlink shared channel (PDSCH), a physical uplink shared channel (PUSCH), or a physical sidelink shared channel (PSSCH).

The processor 220 may process (e.g., encode and symbol map) the data and control information to obtain data symbols and control symbols, respectively. The transmit processor 220 may also generate reference symbols, such as for the primary synchronization signal (PSS), secondary synchronization signal (SSS), PBCH demodulation reference signal (DMRS), and channel state information reference signal (CSI-RS). A transmit (TX) multiple-input multiple-output (MIMO) processor 230 may perform spatial processing (e.g., precoding) on the data symbols, the control symbols, and/or the reference symbols, if applicable, and may provide output symbol streams to the modulators (MODs) in transceivers 232a-232t. Each modulator in transceivers 232a-232t may process a respective output symbol stream (e.g., for OFDM, etc.) to obtain an output sample stream. Each modulator may further process (e.g., convert to analog, amplify, filter, and upconvert) the output sample stream to obtain a downlink signal. Downlink signals from the modulators in transceivers 232a-232t may be transmitted via the antennas 234a-234t, respectively.

At the UE 120a, the antennas 252a-252r may receive the downlink signals from the BS 110a and may provide received signals to the demodulators (DEMODs) in transceivers 254a-254r, respectively. Each demodulator in transceivers 254a-254r may condition (e.g., filter, amplify, downconvert, and digitize) a respective received signal to obtain input samples. Each demodulator may further process the input samples (e.g., for OFDM, etc.) to obtain received symbols. A MIMO detector 256 may obtain received symbols from all the demodulators in transceivers 254a-254r, perform MIMO detection on the received symbols if applicable, and provide detected symbols. A receive processor 258 may process (e.g., demodulate, deinterleave, and decode) the detected symbols, provide decoded data for the UE 120a to a data sink 260, and provide decoded control information to a controller/processor 280.

On the uplink, at UE 120a, a transmit processor 264 may receive and process data (e.g., for the physical uplink shared channel (PUSCH)) from a data source 262 and control information (e.g., for the physical uplink control channel (PUCCH) from the controller/processor 280. The transmit processor 264 may also generate reference symbols for a reference signal (e.g., for the sounding reference signal (SRS)). The symbols from the transmit processor 264 may be precoded by a TX MIMO processor 266 if applicable, further processed by the modulators in transceivers 254a-254r (e.g., for SC-FDM, etc.), and transmitted to the BS 110a. At the BS 110a, the uplink signals from the UE 120a may be received by the antennas 234, processed by the demodulators in transceivers 232a-232t, detected by a MIMO detector 236 if applicable, and further processed by a receive processor 238 to obtain decoded data and control information sent by the UE 120a. The receive processor 238 may provide the decoded data to a data sink 239 and the decoded control information to the controller/processor 240.

The memories 242 and 282 may store data and program codes for BS 110a and UE 120a, respectively. A scheduler 244 may schedule UEs for data transmission on the downlink and/or uplink.

Antennas 252, processors 266, 258, 264, and/or controller/processor 280 of the UE 120a and/or antennas 234, processors 220, 230, 238, and/or controller/processor 240 of the BS 110a may be used to perform the various techniques and methods described herein. For example, as shown in FIG. 2, the controller/processor 240 of the BS 110a has a RACH manager 241 that may be representative of the RACH manager 112, according to aspects described herein. As shown in FIG. 2, the controller/processor 280 of the UE 120a has a RACH manager 281 that may be representative of the RACH manager 122, according to aspects described herein. Although shown at the controller/processor, other components of the UE 120a and BS 110a may be used to perform the operations described herein.

While the UE 120a is described with respect to FIGS. 1 and 2 as communicating with a BS and/or within a network, the UE 120a may be configured to communicate directly with/transmit directly to another UE 120, or with/to another wireless device without relaying communications through a network. In some embodiments, the BS 110a illustrated in FIG. 2 and described above is an example of another UE 120.

NR may utilize orthogonal frequency division multiplexing (OFDM) with a cyclic prefix (CP) on the uplink and downlink. NR may support half-duplex operation using time division duplexing (TDD). OFDM and single-carrier frequency division multiplexing (SC-FDM) partition the system bandwidth into multiple orthogonal subcarriers, which are also commonly referred to as tones, bins, etc. Each subcarrier may be modulated with data. Modulation symbols may be sent in the frequency domain with OFDM and in the time domain with SC-FDM. The spacing between adjacent subcarriers may be fixed, and the total number of subcarriers may be dependent on the system bandwidth. The minimum resource allocation, called a resource block (RB), may be 12 consecutive subcarriers. The system bandwidth may also be partitioned into subbands. For example, a subband may cover multiple RBs. NR may support a base subcarrier spacing (SCS) of 15 KHz and other SCS may be defined with respect to the base SCS (e.g., 30 kHz, 60 kHz, 120 kHz, 240 kHz, etc.).

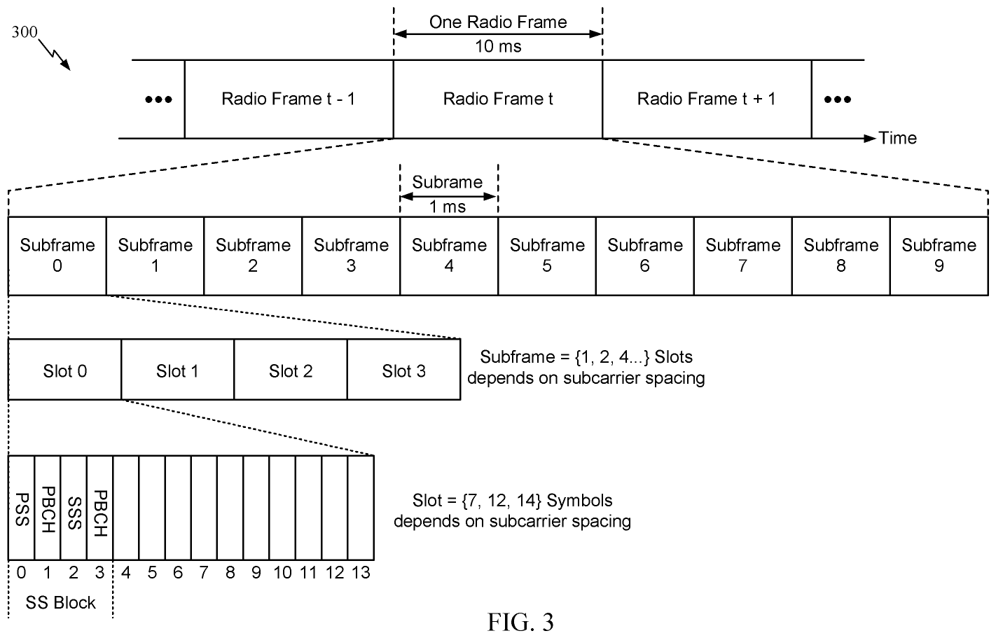

FIG. 3 is a diagram showing an example of a frame format 300 for NR. The transmission timeline for each of the downlink and uplink may be partitioned into units of radio frames. Each radio frame may have a predetermined duration (e.g., 10 ms) and may be partitioned into 10 subframes, each of 1 ms, with indices of 0 through 9. Each subframe may include a variable number of slots (e.g., 1, 2, 4, 8, 16, . . . slots) depending on the SCS. Each slot may include a variable number of symbol periods (e.g., 7, 12, or 14 symbols) depending on the SCS. The symbol periods in each slot may be assigned indices. A sub-slot structure may refer to a transmit time interval having a duration less than a slot (e.g., 2, 3, or 4 symbols). Each symbol in a slot may be configured for a link direction (e.g., downlink (DL), uplink (UL), or flexible) for data transmission and the link direction for each subframe may be dynamically switched. The link directions may be based on the slot format. Each slot may include DL/UL data as well as DL/UL control information.

In NR, a synchronization signal block (SSB) is transmitted. In certain aspects, SSBs may be transmitted in a burst where each SSB in the burst corresponds to a different beam direction for UE-side beam management (e.g., including beam selection and/or beam refinement). The SSB includes a PSS, a SSS, and a two symbol PBCH. The SSB can be transmitted in a fixed slot location, such as the symbols 0-3 as shown in FIG. 3. The PSS and SSS may be used by UEs for cell search and acquisition. The PSS may provide half-frame timing, the SS may provide the CP length and frame timing. The PSS and SSS may provide the cell identity. The PBCH carries some basic system information, such as downlink system bandwidth, timing information within radio frame, SS burst periodicity, system frame number, etc. The SSBs may be organized into an SS burst to support beam sweeping. Further system information such as, remaining minimum system information (RMSI), system information blocks (SIBs), other system information (OSI) can be transmitted on a physical downlink shared channel (PDSCH) in certain subframes. The SSB can be transmitted up to sixty-four times within an SS burst, for example, with up to sixty-four different beam directions for mm Wave. The multiple transmissions of the SSB are referred to as an SS burst in a half radio frame. SSBs in an SS burst may be transmitted in the same frequency region, while SSBs in different SS bursts can be transmitted at different frequency regions.

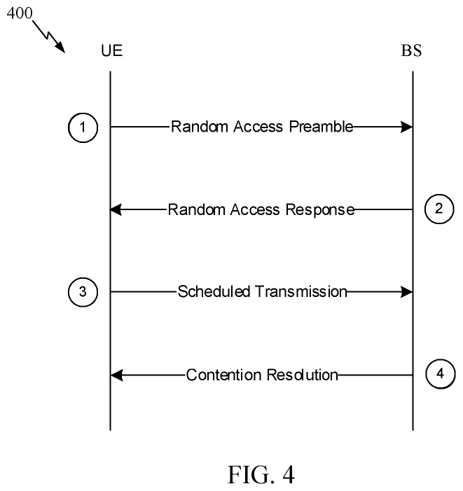

In various scenarios, a UE may communicate with a network entity (such as a base station) via a random access channel (RACH) procedure. For example, the UE may use a RACH procedure for initial radio resource control (RRC) connection setup, RRC connection re-establishment, a handover scenario, a scheduling request failure, beam recovery, downlink or uplink data arrival, etc. FIG. 4 illustrates an example four-step RACH procedure 400, in accordance with certain aspects of the present disclosure. In a first message (MSG1), the UE transmits a random access (RA) preamble to the BS. The UE may monitor for a response from the BS within a configured time window. The UE may receive the random access response (RAR) from the BS, where the RAR may include uplink scheduling for the UE. Upon reception of the RAR, the UE sends a third message (MSG3) using the uplink grant scheduled in the response and monitors for contention resolution. If contention resolution is not successful after the MSG3 transmission and/or retransmission(s) of MSG3, the UE may go back to MSG1 transmission.

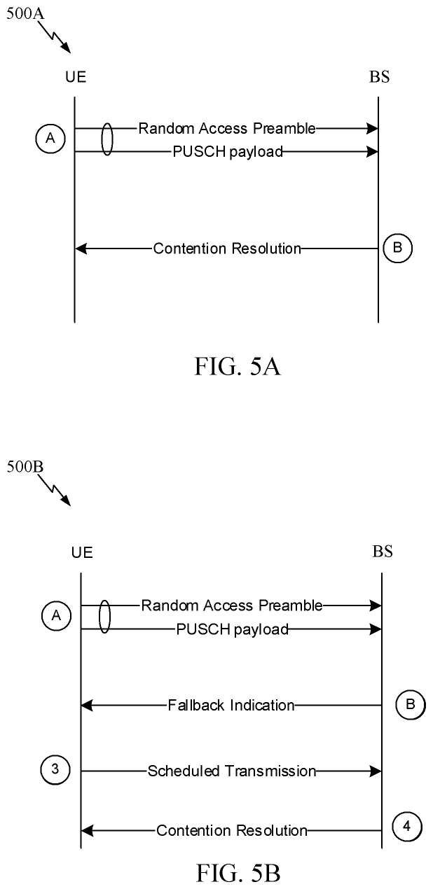

FIG. 5A illustrates an example of a two-step RACH procedure 500A, where contention resolution is successful at the BS, in accordance with certain aspects of the present disclosure. The UE may transmit in a first message (MSGA) including a preamble on a physical random access channel (PRACH) and a payload on a PUSCH. After the MSGA transmission, the UE monitors for a response from the BS within a configured time window. If contention resolution is successful upon receiving the network response (MSGB), the UE ends the random access procedure, and in certain cases, the UE may communicate with the BS in a connected state.

FIG. 5B illustrates an example of a two-step RACH procedure 500B, where contention resolution is unsuccessful at the BS, in accordance with certain aspects of the present disclosure. In this example, if a fallback indication is received in MSGB, the UE may perform MSG3 transmission using the UL grant scheduled in the fallback indication and monitors contention resolution. If contention resolution is not successful after MSG3 transmission and/or retransmissio(s), the UE may go back to the MSGA transmission. FIGS. 4, 5A and 5B illustrate examples of contention-based random access (CBRA) procedures to facilitate understanding. Aspects of the present disclosure may also apply to contention-free random access (CFRA) procedures, where the network may initially provide a RA preamble and/or uplink resource assignment to the UE.

Certain wireless communication systems (e.g., Evolved Universal Terrestrial Radio Access (E-UTRA) system and/or NR system) may enable access to network services using a physical layer configured for very low power consumption and low complexity, which may be beneficial for Internet-of-Things (IOT) devices operating on battery power. These low power network services may be referred to as narrowband IoT (NB-IOT) operations. Under NB-IOT operations, a UE may support data rates up to 68 kbps for downlink and up to 132 kbps for uplink, for example, via a full carrier bandwidth of 180-200 kHz and a subcarrier spacing of 3.75 kHz or 15 kHz. At such a low bandwidth, the NB-IOT may support a low complexity transceiver to enable a low cost solution for IoT devices. In certain cases, a UE may be equipped with only a single antenna to facilitate low power consumption. The low power consumption may enable an NB-IOT device to operate for at least 10 years on battery power. Those of skill in the art will understand that the parameters for configuring NB-IOT operations are exemplary only. Additional parameters or categories of parameters may be used in addition to or instead of those described.

NR systems may support an intermediary narrowband device, which may be referred to as a reduced capability (RedCap) device. The RedCap device may support a bandwidth greater than NB-IOT devices but less than the full bandwidth capacity supported for NR communications. For example, the RedCap device may support a bandwidth of 20 MHz in FR1 and 100 MHz in FR2, whereas a baseline NR device supports a bandwidth of 100 MHz in FR1 and 200 MHz in FR2. The RedCap device may have other capability restrictions, such as fewer receiver branches, downlink MIMO layers, and downlink modulation orders compared to a baseline NR device. In certain cases, the RedCap device may also only support half-duplex communications. The RedCap device may enable a device with a lower cost and reduced complexity as compared to high-end eMBB and URLLC devices. The RedCap device may be used for wearables, industrial wireless sensors, and/or video surveillance equipment.

In an industrial wireless sensor use case, the communication service availability may be highly reliable providing an availability of 99.99%, and end-to-end latency may be less than 100 ms. The reference bit rate may be less than 2 Mbps (potentially asymmetric e.g. UL heavy traffic), and the device may be expected to be stationary. The battery may be expected to last at least a few years. For safety related sensors, latency may be lower, 5-10 ms. In the video surveillance use case, the video bitrate may be 2-4 Mbps having a latency less than 500 ms and high reliability of 99%-99.9%. High-end video (e.g. for farming) may require 7.5-25 Mbps. The traffic pattern is dominated by UL transmissions. In the wearable use case, the bitrate for smart wearable application can be 5-50 Mbps in DL and 2-5 Mbps in UL, and peak bit rate of the device may be higher, for example, up to 150 Mbps for downlink and up to 50 Mbps for uplink. The battery of the device may be expected to last multiple days.

NR systems may support a small data transmission from a UE in a non-connected mode (e.g., an inactive mode). Transitioning from an inactive state into a connected mode just to send a small amount of data creates increased signaling overhead in the network and increased battery consumption at the UE. For devices supporting eMBB services, applications can have frequent background small data (e.g. requests for refreshing application data, notifications, etc.), which may be periodic or aperiodic. Sensors and IoT devices may have considerable amount of signalling and small data (e.g. periodic heartbeat or stay-alive signals, surveillance updates, periodic video stream, non-periodic video based on motion sensing). In certain cases, the UE may send the small data transmission via a RACH procedure (such as the RACH procedures described herein with respect to FIGS. 4, 5A, and 5B) in an inactive state. As used herein, a small data transmission may refer to a data transmission having a size for transmitting background application data (e.g., requests for refreshing application data, notifications, etc.) or data uploaded by sensors and/or IoT devices (e.g., periodic heartbeat or stay-alive signals, surveillance updates, periodic video stream, non-periodic video based on motion sensing).

In certain wireless communication networks, the network may provide RACH partitioning for certain UE capabilities (such as capabilities for narrowband communications (NB-IOT or RedCap), eMBB, URLLC, and/or coverage enhancement) and/or services (such as a small data transmission and/or radio access network (RAN) slicing). For example, the network may separate RACH resources into non-overlapping RACH occasions for specific capabilities and/or services. In certain cases, RACH preambles may be partitioned for specific capabilities and/or services. For example, a group of preambles may be reserved for URLLC applications to facilitate the low latency of a two-step RACH procedure and provide prioritization for the URLLC. When RACH resources are partitioned for too many capabilities and/or services, there may be loss of efficiency, which may cause resource fragmentation and/or losses in trunking gains.

### Example Capability or Service Indication Over Random Access Channel

Aspects of the present disclosure provide techniques and apparatus for indicating a capability and/or service over a RACH. The indication described herein may facilitate the network to dynamically respond to the capabilities of a UE and/or a service indicated by the UE. For example, an indication of a UE capability or service may enable the network to prioritize the response time for ultra-low latency or prioritized RAN slicing. In certain cases, the indication of the UE capability or service may inform the network of a specific RACH configuration, such as power ramping step, a backoff scaling factor, or a response window assigned to the UE. In certain cases, the indication of the UE capability or service may enable the network to assign a dedicated resource for the PUSCH payload or inform the network that the UE is using the dedicated resource for the PUSCH payload.

The indication of the UE capability or service may enable a dynamic response from the network, which may facilitate desirable resource and/or preamble partitioning. The indication of the UE capability or service may enable desirable performance for certain scenarios, such as dedicated resources for small data transmissions, shorter response windows for low latency or URLLC services, and/or a specific bandwidth configuration for narrowband UEs. The indication of the UE capability or service may facilitate desirable wireless communication performance, such as desirable data rates, spectral efficiency, and/or latencies.

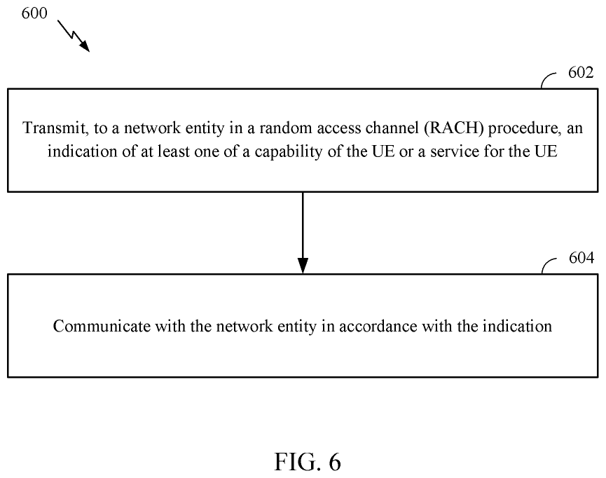

FIG. 6 is a flow diagram illustrating example operations 600 for wireless communication, in accordance with certain aspects of the present disclosure. The operations 600 may be performed, for example, by a UE (such as the UE 120a in the wireless communication network 100). The operations 600 may be implemented as software components that are executed and run on one or more processors (e.g., controller/processor 280 of FIG. 2). Further, the transmission and reception of signals by the UE in operations 600 may be enabled, for example, by one or more antennas (e.g., antennas 252 of FIG. 2). In certain aspects, the transmission and/or reception of signals by the UE may be implemented via a bus interface of one or more processors (e.g., controller/processor 280) obtaining and/or outputting signals.

The operations 600 may begin, at block 602, where the UE may transmit, to a network entity in a RACH procedure (e.g., the RACH procedures described herein with respect to FIGS. 4, 5A, and/or 5B), an indication of at least one of a capability of the UE or a service for the UE. For example, the UE may transmit an indication of a capability that the UE communicates via a narrowband, such as the bandwidth associated with a RedCap device or a NB-IOT device. In certain cases, the UE may transmit an indication that the UE will be sending one or more small data transmissions. Transmission of the indication in the RACH procedure may refer to the UE transmitting the indication via at least one of the uplink messages during a RACH procedure, such as MSG1, MSG3, and/or MSGA as described herein with respect to FIGS. 4, 5A, and 5B.

At block 604, the UE may communicate with the network entity in accordance with the indication. Communications at the UE may include a transmission to the network entity and/or a reception from the network entity. Communicating at block 604 may include the UE transmitting data to the network entity and/or receiving data from the network entity, for example. As an example, the UE may transmit a payload via frequency domain resources in a narrowband (e.g., NB-IOT or RedCap), for example, in the case where the UE communicates via a narrowband.

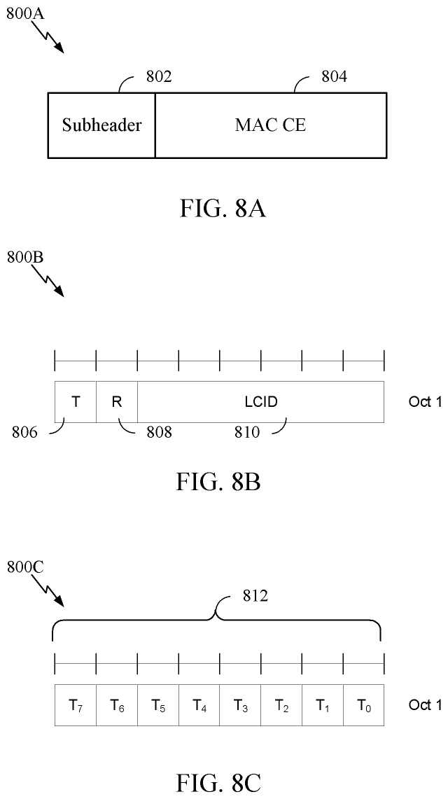

In certain aspects, the UE may provide the indication via control signaling such as control signaling in the medium access control (MAC) layer or a message from a control plane protocol stack. For example, the UE may provide the indication via a MAC control element (CE) or MAC packet, as further described herein with respect to FIGS. 8A-8C. The MAC CE may have a fixed size, for example, of one byte. In certain cases, the MAC CE may have a variable size, where the length of the MAC CE may be indicated in the subheader. The MAC CE may be sent via MSGA in the PUSCH payload of a two-step RACH procedure or MSG3 in the PUSCH payload of a four-step RACH procedure. The MAC CE may indicate the UE capability (e.g., a specific type of UE) or which type of service the UE will have with the network. The MAC subheader for the MAC CE may have two reserved bits and a logical channel identifier (LCID), for example, in the format: R/R/LCID.

The MAC CE may include a bitmap associated with the capability or service. In certain cases, each bit may be a separate field associated with a specific UE capability or service. For example, the first bit in the bitmap sequence may be associated with a capability for a narrowband type UE (e.g., NB-IOT or reduced capability), and the second bit in the bitmap sequence may be associated with a service for small data transmissions. The UE may set one or more bits in the bitmap to indicate its capabilities and/or services within the MAC CE. As an example, a narrowband UE (such as a reduced capability device) having a small data service may set the two bits associated with the reduced capability device and small data service to “1” and the other bits to “0” in the MAC CE.

For certain aspects, the MAC subheader of a MAC packet or MAC CE may be used to indicate the capability or service for the UE. For example, the indication in the operations 600 may be provided via a MAC subheader of a MAC CE or MAC packet, as further described herein with respect to FIGS. 8A-8C. In certain cases, the subheader may indicate the capability or service, and the MAC CE may be empty (e.g., zero bits). The MAC subheader may include an LCID having one or more codepoints associated with the capability or service. For example, in certain wireless communications standards, LCID values 35-44 are reserved values. Some of these values may be repurposed for indicating the capability or service for the UE. For example, an LCID value of 44 may be for Redcap; an LCID value of 43 may be for a small data service; an LCID value of 42 may be for RAN Slicing; and etc. An LCID codepoint value may be associated one or more capabilities and/or services.

In certain aspects, the MAC subheader includes a bit flag and a bit array, where the bit flag indicates whether the bit array includes the capability or the service, and the bit array includes one or more codepoints associated with the capability or the service. For example, the MAC subheader may have a bit field (such as a T field) and a LCID field. The bit field may indicate whether the LCID field represents a channel identifier or represents the capability or service. As an example, if the bit flag is set to ‘1’, the bit array may indicate the capability and/or service. The codepoints for the bit array may be associated with one or more capabilities and/or one or more services. Otherwise, if the bit flag is set to ‘0’, the bit array may indicate an LCID or any other suitable indication. In certain cases, the leftmost bit in the subheader may be the bit flag that indicates whether the bit array indicates the capability or service.

In aspects, the indication may be indicated by a specific aspect of the preamble transmission and/or payload transmission. For example, the RACH preamble sequence (e.g., specific root(s) and/or cyclic shift(s)) may indicate the capability or service. The DMRS sequence for the payload (e.g., specific initialization(s) and/or cyclic shift(s)) may indicate the capability or service. The location in frequency and/or time for a RACH transmission (e.g., the preamble and/or payload) may indicate the capability or service. The subcarrier spacing for a RACH transmission (e.g., the preamble or payload) may indicate the capability or service. With respect to the operations 600, the indication may include a preamble sequence value that indicates the capability or the service. In certain cases, the indication may include a DMRS sequence value that indicates the capability or the service. That is, the indication may be provided via at least the preamble sequence and/or DMRS sequence.

For certain aspects, the UE may be configured with certain RACH parameters to use for a specific capability and/or service. The UE may be preconfigured with the RACH parameters associated with the capability and/or service. In certain cases, the network may configure the UE with RACH parameters associated with the capability or service. For example, the network entity may configure separate RACH parameters for the preamble and/or payload transmission that can be used for a certain capability and/or service. The UE may select RACH parameters from a set of RACH parameters corresponding to the UE's capabilities and/or the service, for example, for the preamble and/or payload transmission. As an example, suppose the network reserves a specific set of preamble sequences and/or PRACH resources for small data transmissions to facilitate desirable contention resolution, priority handling, and/or reliability. The UE may transmit the preamble using a sequence from the configured set of preamble sequences when the UE uses the RACH procedure for a small data transmission, such as a request to refresh application content.

With respect to the operations 600, the UE may receive a configuration for one or more random access parameters associated with the capability or the service. The UE may perform the RACH procedure according to the random access parameters associated with the capability or service. That is, the UE may apply the random access parameters when performing the RACH procedure with the capability and/or for the service. In certain cases, performing the RACH procedure may include transmitting the indication. The random access parameter(s) may include at least one of a power ramping step for the RACH procedure, a target received power level of preambles at the network entity, a backoff scaling factor used to determine a preamble backoff time, a response window for a random access response in the RACH procedure, a total number of RACH preambles, a maximum transmit power for a preamble, an offset of a lowest RACH transmission occasion in the frequency domain, a number of RACH transmission occasions in a slot, or a pattern in the time domain for RACH transmission occasions. In certain cases, the configuration may include a PUSCH resource allocation for a message (e.g., MSGA or MSG3) to the network entity in the RACH procedure. Those of skill in the art will appreciate that the random access parameters described herein are exemplary only. Other random access parameters or categories of random access parameters may be used in addition to or instead of those described herein.

In certain cases, the UE may or may not repeat the indication in response to a random access response from the network entity, such as a fallback indication (MSGB) in a two-step RACH procedure (e.g., the RACH procedure 500B). Suppose the UE receives a fallback RAR during a two-step RACH procedure where the network only decodes the preamble of MSGA successfully but fails on the payload of MSGA. The UE may detect a flag in the fallback RAR indicating to fallback to a RRC resume procedure instead of a small data procedure. In such a case, the UE may give up sending the indication of the capability or service with the payload. The UE may send the payload with other information in a MAC packet (e.g., a MAC protocol data unit (PDU)), for example. For a small data case, the UE may only send a common control channel (CCCH) message in MSG3 to perform the RRC Resume procedure. In aspects, the UE may refrain from sending the indication again based on the UE capability or service, such as a small data transmission. With respect to the operations 600, the UE may receive, from the network entity, a fallback indication having an uplink resource grant, and the UE may transmit, to the network entity, a payload without the indication via the uplink resource grant.

In certain cases, the UE may send the indication of the UE capability or service in the MSG3 transmission. For example, the UE may send the indication in a MAC CE without changing MAC PDU payload. That is, the UE may retransmit the indication in the MAC CE and CCCH message in MSG3 to the network for contention resolution. With respect to the operations 600, the UE may receive, from the network entity, a fallback indication having an uplink resource grant, and the UE may transmit, to the network entity, a payload with the indication via the uplink resource grant.

The capability indicated at block 602 may be one or more capabilities of the UE. The capability in the operation 600 may include at least one of a narrowband capability (such as NB-IOT or RedCap), a coverage enhancement capability (such as repetition techniques for NB-IOT or MTC devices), an eMBB capability, or an URLLC capability.

The service indicated at block 602 may be one or more services for the UE. For example, the service may include at least one of a small data transmission (such as application background data, IOT signaling, or IoT updates), random access resource isolation for radio access network (RAN) slicing (such as resources reserved for certain services), or random access prioritization for RAN slicing (such as latency priorities).

For certain aspects, the RACH procedure may be performed via a common resource pool for random access. For example, the UE may transmit the indication via the common resource pool for random access.

In certain aspects, the indication may be sent during a four-step RACH procedure, such as the RACH procedure 400. The UE may transmit, to the network entity, a random access preamble (MSG1), and the UE may receive, from the network entity, a response (MSG2) to the random access preamble having an uplink resource grant. The UE may transmit, to the network entity, a payload (MSG3) via the uplink resource grant, and the UE may receive, from the network entity in response to the payload, acknowledgement of contention resolution (MSG4). In the four-step RACH procedure, the random access preamble and/or the payload may include the indication.

In aspects, the indication may be sent during a two-step RACH procedure, such as the RACH procedure 500A. The UE may transmit, to the network entity, a message (MSGA) including a random access preamble on a PRACH and a payload on a PUSCH, and the UE may receive, from the network entity in response to the message, acknowledgement of contention resolution (MSGB). In the two-step RACH procedure, the random access preamble and/or the payload may include the indication.

For certain aspects, the network entity may take one or more actions in response to the indication. For example, the network entity may allocate certain resources for the payload in a four-step RACH procedure, respond within a certain response window (such as a short response window for low latency services or prioritizations), and/or configure the UE with specific RACH parameters for the capability or service. When the network entity receives the indication, the network entity may identify the capability of the UE and/or service for the UE. The network entity may respond based on the capability or service.

In the narrowband use case, the UE may communicate with the network entity via a bandwidth configured for a RedCap device and/or NB-IOT device. For example, the UE may communicate with the network entity via a bandwidth of 20 MHz in the FR1 bands in response to the UE indicating that the UE is a RedCap device at block 602. In the small data scenario, the UE may receive a random access response message having an uplink resource grant dedicated to a small data transmission, for example, if the network was unable to decode a prior payload transmission, and the UE may transmit, to the network entity, the payload via the uplink resource grant. In a low latency use case, the UE may receive, from the network entity in response to the indication, acknowledgement of contention resolution within a response window configured for low latency communications (e.g., for RAN slicing prioritization or URLLC).

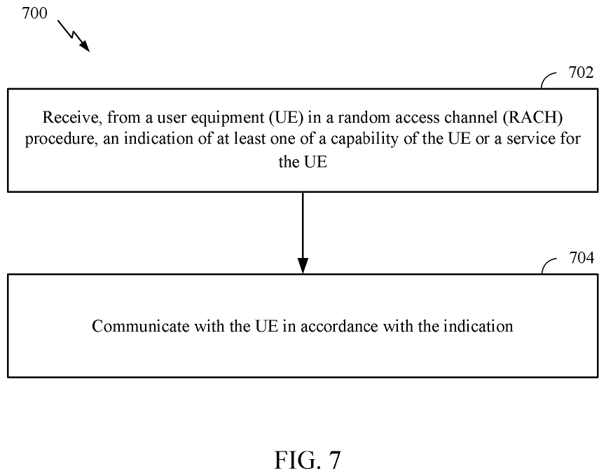

FIG. 7 is a flow diagram illustrating example operations 700 for wireless communication, in accordance with certain aspects of the present disclosure. The operations 700 may be performed, for example, by a network entity (such as the BS 110a in the wireless communication network 100). The operations 700 may be complementary to the operations 600 performed by the UE. The operations 700 may be implemented as software components that are executed and run on one or more processors (e.g., controller/processor 240 of FIG. 2). Further, the transmission and reception of signals by the network entity in operations 700 may be enabled, for example, by one or more antennas (e.g., antennas 234 of FIG. 2). In certain aspects, the transmission and/or reception of signals by the network entity may be implemented via a bus interface of one or more processors (e.g., controller/processor 240) obtaining and/or outputting signals. As used herein, the network entity may refer to a wireless communication device in a radio access network, such as a base station, a remote radio head or antenna panel in communication with a base station, and/or network controller.

The operations 700 may begin, at block 702, where the network entity may receive, from a UE (e.g., the UE 120) in a RACH procedure (e.g., the RACH procedures described herein with respect to FIGS. 4, 5A, and/or 5B), an indication of at least one of a capability of the UE or a service for the UE. For example, the network entity may receive an indication of a capability that the UE communicates via a narrowband, such as the bandwidth associated with a RedCap device or a NB-IOT device. Reception of the indication in the RACH procedure may refer to the network entity receiving the indication via at least one of the uplink messages during a RACH procedure, such as MSG1, MSG3, and/or MSGA as described herein with respect to FIGS. 4, 5A, and 5B.

At block 704, the network entity may communicate with the UE in accordance with the indication. For example, the network entity may receive transmission from the UE via frequency resources in the narrowband indicated at block 702.

In certain aspects, the network entity may receive the indication via control signaling such as control signaling in the MAC layer or a message from a control plane protocol stack, for example, as described herein with respect to the operations 600. As an example, the indication may be provided via a MAC CE, such as a MAC subheader and/or a MAC CE, as described herein with respect to the operations 600.

In certain cases, the indication may be provided via the preamble transmission and/or payload transmission, as described herein with respect to the operations 600. The indication may include a preamble sequence value that indicates the capability or the service. The indication may include a DMRS sequence value that indicates the capability or the service. That is, the indication may be provided via at least the preamble sequence and/or DMRS sequence.

For certain aspects, the network entity may configure the UE with certain RACH parameters to use for a specific capability and/or service, for example, as described herein with respect to the operations 600. The network entity may configure the UE preemptively (e.g., before receiving the indication) or in response to the indication. The network entity may transmit, to the UE, a configuration for one or more random access parameters associated with the capability or the service, and the network entity may perform the RACH procedure according to the random access parameters. The configuration may include a PUSCH resource allocation for a message (e.g., MSGA or MSG3) to the network entity in the RACH procedure.

In certain cases, the UE may or may not repeat the indication in response to a random access response from the network entity, for example, as described herein with respect to the operations 600. In certain cases, the network entity may transmit, to the UE, a fallback indication having an uplink resource grant, and the network entity may receive, from the UE, a payload without the indication via the uplink resource grant. In certain cases, the network entity may transmit, to the UE, a fallback indication having an uplink resource grant, and the network entity may receive, from the UE, a payload with the indication via the uplink resource grant.

In certain aspects, the random access preamble or the payload may include the indication in a four-step RACH procedure or a two-step RACH procedure.

FIG. 8A is a diagram illustrating an example MAC packet 800A (e.g., a portion of a MAC PDU) including a subheader 802 and a MAC CE 804, in accordance with certain aspects of the present disclosure. The subheader 802 may provide information related to the payload of the MAC CE 804. The subheader 802 may include one or more bit fields and/or one or more bit arrays (e.g., a LCID field) associated with the content of the MAC CE 804. The MAC CE 804 may configure, enable, disable, or provide information related to various MAC parameters. For example, the MAC CE 804 may provide a buffer status report or indicate whether to activate certain Transmission Configuration Indicator (TCI) states. Aspects of the present disclosure provide various techniques for indicating a capability or service using a MAC CE or MAC packet, as described herein with respect to the operations 600. It will be appreciated that the MAC CE 804 illustrated in FIG. 8A is merely an example of a payload of the MAC packet 800A, and the MAC packet 800A may include other payloads in addition to or instead of the MAC CE, such as a CCCH message.

FIG. 8B is a diagram illustrating an example subheader format 800B for indicating one or more UE capabilities or services, in accordance with certain aspects of the present disclosure. In this example, the subheader format 800B may include a first bit field 806, a second bit field 808, and an LCID field 810, which may have a length of 6 bits. In certain cases, the first bit field 806 may indicate whether the LCID field 810 represents an LCID or represents a capability or service for the UE. The second bit field 808 may be a reserved bit field, and the LCID field 810 may be a bit array having certain codepoint values associated with one or more capabilities and/or one or more services. That is, a specific codepoint value in the LCID field 810 may indicate a separate capability, a separate service, or a combination of capabilities and/or services. In certain cases, the first and second bit fields 806, 808 may be reserved fields, and certain codepoint values for the LCID field 810 may indicate one or more capabilities and/or one or more services, and other codepoint values may indicate LCIDs. In other words, the codepoint values for the LCID field 810 may represent an LCID, a separate capability, a separate service, or a combination of capabilities and/or services

FIG. 8C is a diagram illustrating an example MAC CE format 800C for indicating one or more UE capabilities or services, in accordance with certain aspects of the present disclosure. The MAC CE format 800C may have a bit array 812, which in this example is 8 bits in length. The bit array 812 may have codepoint values associated with one or more capabilities and/or one or more services. A specific codepoint value may indicate a separate capability, a separate service, or a combination of capabilities and/or services. In certain cases, the bit array 812 may be a bit map where each bit (T₀-T₇) in the bit array 812 may be a bit flag that represents a separate capability, a separate service, or a combination of capabilities and/or services. For example, the bit T₀ may indicate whether the UE has a narrowband capability, and the bit T₁ may indicate whether the UE is sending a small data transmission.

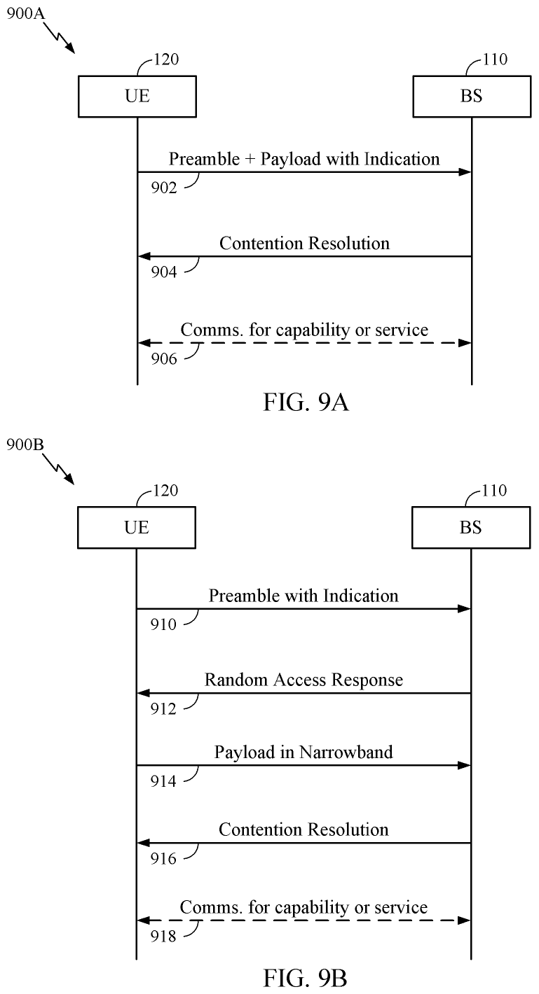

FIG. 9A is a signaling flow diagram illustrating example signaling 900A for indicating one or more UE capabilities or services in a two-step RACH procedure, in accordance with certain aspects of the present disclosure. At activity 902, the UE 120 may transmit a preamble on a PRACH and payload on a PUSCH, where the preamble and/or payload may include an indication of the UE capability or service, as described herein. For example, the payload may include a MAC packet with a subheader indicating the UE capability. As an example, the indication may indicate that the UE is requesting a low latency response as an aspect of RAN slicing. The BS 110 may identify the capability or service indicated at activity 902, and the BS 110 may take one or more actions in response to the indication. For example, in response to a low latency request, the BS 110 may respond at activity 904 in a low latency response window (e.g., a shorter response window than for other services or capabilities).

As another example, the indication may indicate that the UE 120 is requesting a highly reliable RACH procedure. Suppose in this case, the preamble provides the indication of the service request for the UE 120, and the payload includes data subject to the reliability requirement, such as IoT sensor data. In such a case, the BS 110 may identify from the preamble that the UE used dedicated resources for the payload transmission to provide a desirable reliability of decoding the payload at the BS 110.

At activity 904, the BS 110 may transmit an acknowledgement of successful contention resolution to the UE 120.

Optionally, at activity 906, the UE 120 may communicate with the BS 110 in accordance with the indication. Suppose the indication provides a narrowband capability of the UE, such that at activity 906, the UE 120 may receive data from the BS 110 via narrowband frequency resources.

In certain cases, the indication at activity 902 may indicate that the UE has a small data transmission to send, and in response to the small data transmission service request, the BS 110 may send at activity 904 an uplink grant that provides resources available for a subsequent small data transmission. At activity 906, the UE 120 may transmit the small data payload via the resources granted at activity 904.

FIG. 9B is a signaling flow diagram illustrating example signaling 900B for indicating one or more UE capabilities or services in a four-step RACH procedure, in accordance with certain aspects of the present disclosure. At activity 910, the UE 120 may send a preamble, where the preamble may optionally be or carry an indication of the UE capability or service. In certain aspects, if the preamble is configured for the specific capability UE or service in terms of a specific sequence and/or resource, the preamble may be the indication. For example, the indication may indicate that the UE 120 supports a narrowband bandwidth (e.g., NB-IOT or RedCap). The BS 110 may identify the capability of the UE based on the indication, and at activity 912, the BS 110 may send a random access response scheduling uplink resources in a narrowband bandwidth. At activity 914, the UE 120 may transmit a payload with the scheduled resources in the narrowband, such as the RedCap bandwidth. In certain cases, the payload may include the indication of the UE capability or service, for example, in a MAC packet with a subheader indicating the UE capability or service, as described herein. At activity 916, the BS 110 may transmit an acknowledgement of successful contention resolution to the UE 120. Optionally, at activity 918, the UE 120 may communicate with the BS 110 in accordance with the indication. For example, the UE 120 may transmit data to the BS 110 via narrowband frequency resources in accordance with the UE's narrowband capability.

In certain cases, the UE 120 may indicate a request for a small data transmission at activity 910. In response to the small data request, the BS 110 may send an uplink grant at activity 912 with resources available for the small data transmission. At activity 914, the UE 120 may transmit the small data payload using the uplink resources provided at activity 912.

It will be appreciated that the capability or service indication described herein may facilitate the network to dynamically respond to the UE's capability and/or service in a RACH procedure. The indication may facilitate early identification of a UE's capability or service at the network (such as within a MSGA transmission of a two-step RACH procedure or a MSG1 transmission of a four-step RACH procedure) and application of the UE's capability or service for other portions of the RACH procedure and/or other communications. The indication described herein may enable desirable wireless communication performance such as desirable data rates, latencies, and/or spectral efficiency.

While the examples depicted in FIGS. 9A and 9B are described herein with respect to specific capabilities and/or services to facilitate understanding, aspects of the present disclosure may also be applied to indicating other capabilities and/or services (e.g., a coverage enhancement capability or a small data transmission service) for the UE, and the network entity responding to such an indication. Those of skill in the art will understand that the various capabilities and services described herein are merely examples, and the techniques described herein for indicating the UE capability or service may be applied to additional or alternative capabilities and/or services (e.g., a subcarrier spacing capability, a modulation capability, duplex capability, etc.).

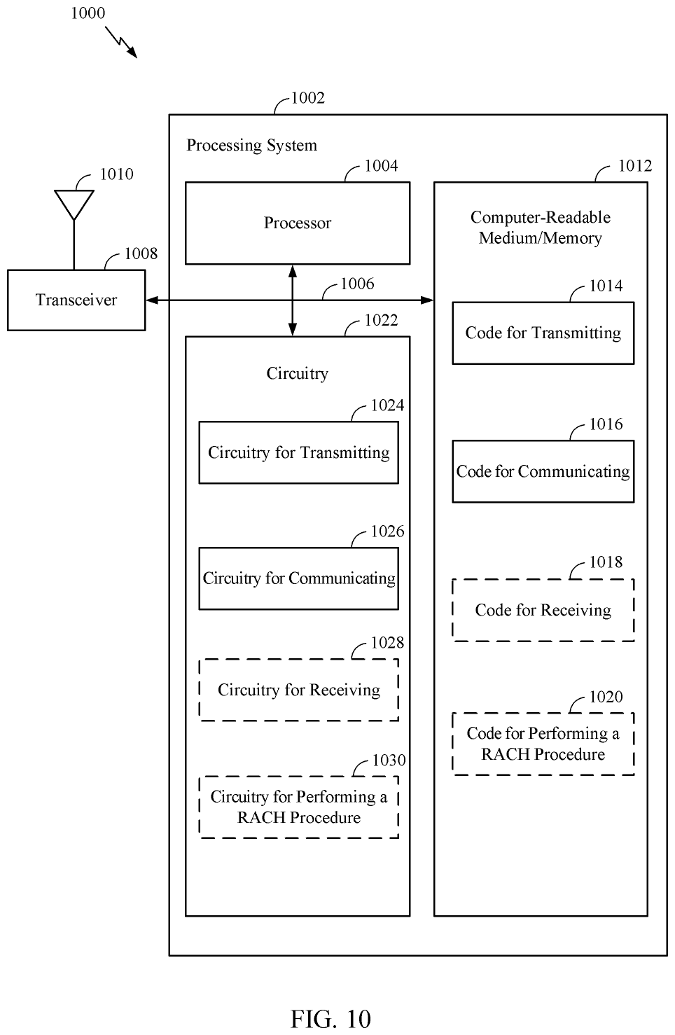

FIG. 10 illustrates a communications device 1000 that may include various components (e.g., corresponding to means-plus-function components) configured to perform operations for the techniques disclosed herein, such as the operations illustrated in FIG. 6. The communications device 1000 includes a processing system 1002 coupled to a transceiver 1008 (e.g., a transmitter and/or a receiver). The transceiver 1008 is configured to transmit and receive signals for the communications device 1000 via an antenna 1010, such as the various signals as described herein. The processing system 1002 may be configured to perform processing functions for the communications device 1000, including processing signals received and/or to be transmitted by the communications device 1000.

The processing system 1002 includes a processor 1004 coupled to a computer-readable medium/memory 1012 via a bus 1006. In certain aspects, the computer-readable medium/memory 1012 is configured to store instructions (e.g., computer-executable code) that when executed by the processor 1004, cause the processor 1004 to perform the operations illustrated in FIG. 6, or other operations for performing the various techniques discussed herein for indicating a UE capability or service in a RACH procedure. In certain aspects, computer-readable medium/memory 1012 stores code for transmitting 1014, code for communicating 1016 (which may include code for transmitting and/or code for receiving), code for receiving 1018, and/or code for performing a RACH procedure 1020. In certain aspects, the processing system 1002 has circuitry 1022 configured to implement the code stored in the computer-readable medium/memory 1012. In certain aspects, the circuitry 1022 is coupled to the processor 1004 and/or the computer-readable medium/memory 1012 via the bus 1006. For example, the circuitry 1022 includes circuitry for transmitting 1024, circuitry for communicating 1026, circuitry for receiving 1028, and/or circuitry for performing a RACH procedure 1030.

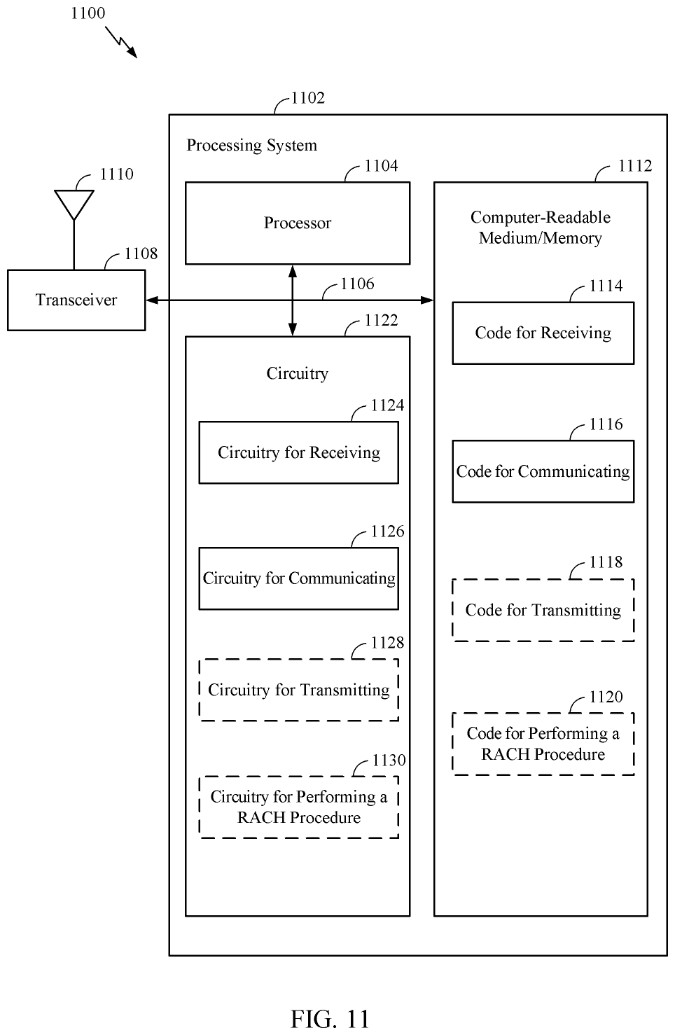

FIG. 11 illustrates a communications device 1100 that may include various components (e.g., corresponding to means-plus-function components) configured to perform operations for the techniques disclosed herein, such as the operations illustrated in FIG. 7. The communications device 1100 includes a processing system 1102 coupled to a transceiver 1108 (e.g., a transmitter and/or a receiver). The transceiver 1108 is configured to transmit and receive signals for the communications device 1100 via an antenna 1110, such as the various signals as described herein. The processing system 1102 may be configured to perform processing functions for the communications device 1100, including processing signals received and/or to be transmitted by the communications device 1100.

The processing system 1102 includes a processor 1104 coupled to a computer-readable medium/memory 1112 via a bus 1106. In certain aspects, the computer-readable medium/memory 1112 is configured to store instructions (e.g., computer-executable code) that when executed by the processor 1104, cause the processor 1104 to perform the operations illustrated in FIG. 7, or other operations for performing the various techniques discussed herein for processing an indication of a UE capability or service in a RACH procedure. In certain aspects, computer-readable medium/memory 1112 stores code for receiving 1114, code for communicating 1116, code for transmitting 1118, and/or code for performing a RACH procedure 1120. In certain aspects, the processing system 1102 has circuitry 1122 configured to implement the code stored in the computer-readable medium/memory 1112. In certain aspects, the circuitry 1122 is coupled to the processor 1104 and/or the computer-readable medium/memory 1112 via the bus 1106. For example, the circuitry 1122 includes circuitry for receiving 1124, circuitry for communicating 1126, circuitry for transmitting 1128, and/or circuitry for performing a RACH procedure 1130.

### EXAMPLE ASPECTS

In addition to the various aspects described above, specific combinations of aspects are within the scope of the disclosure, some of which are detailed below:
Aspect 1: A method of wireless communication by a user equipment (UE), comprising: transmitting, to a network entity in a random access channel (RACH) procedure, an indication of at least one of a capability of the UE or a service for the UE; and communicating with the network entity in accordance with the indication.
Aspect 2: The method of Aspect 1, wherein the indication is provided via a medium access control (MAC) control element (CE).
Aspect 3: The method of Aspect 2, wherein the MAC CE includes a bitmap associated with the capability or the service.
Aspect 4: The method according to any of Aspects 1-3, wherein the indication is provided via a MAC subheader of the MAC CE.
Aspect 5: The method of Aspect 4, wherein the MAC subheader includes a logic channel identifier (LCID) having one or more codepoints associated with the capability or the service.
Aspect 6: The method of Aspect 4, wherein: the MAC subheader includes a bit flag and a bit array; the bit flag indicates whether the bit array includes the capability or the service; and the bit array includes one or more codepoints associated with the capability or the service.
Aspect 7: The method according to any of Aspects 1-6, further comprising: receiving a configuration for one or more random access parameters associated with the capability or the service; and performing the RACH procedure according to the one or more random access parameters, wherein performing the RACH procedure includes transmitting the indication.
Aspect 8: The method of Aspect 7, wherein the one or more random access parameters include at least one of: a power ramping step for the RACH procedure, a target received power level of preambles at the network entity, a backoff scaling factor, a response window for a random access response in the RACH procedure, a total number of RACH preambles, a maximum transmit power for a preamble, an offset of a lowest RACH transmission occasion in the frequency domain, a number of RACH transmission occasions in a slot, or a pattern in the time domain for RACH transmission occasions.
Aspect 9: The method according to any of Aspects 7 or 9, wherein the configuration includes a physical uplink shared channel resource allocation for a message to the network entity in the RACH procedure.
Aspect 10: The method according to any of Aspects 1-9, wherein the indication includes a preamble sequence value that indicates the capability or the service.
Aspect 11: The method according to any of Aspects 1-10, wherein the indication includes a demodulation reference signal sequence value that indicates the capability or the service.
Aspect 12: The method according to any of Aspects 1-11, further comprising: receiving, from the network entity, a fallback indication having an uplink resource grant;
and transmitting, to the network entity, a payload without the indication via the uplink resource grant.
Aspect 13: The method according to any of Aspects 1-11, further comprising: receiving, from the network entity, a fallback indication having an uplink resource grant; and transmitting, to the network entity, a payload with the indication via the uplink resource grant.
Aspect 14: The method according to any of Aspects 1-13, wherein the capability includes at least one of a narrowband capability, a coverage enhancement capability, an enhanced mobile broadband capability, or an ultra-reliable low latency capability.
Aspect 15: The method according to any of Aspects 1-14, wherein the service includes at least one of a small data transmission, random access resource isolation for radio access network (RAN) slicing, or random access prioritization for RAN slicing.
Aspect 16: The method according to any of Aspects 1-15, wherein transmitting comprises transmitting the indication via a common resource pool for random access.
Aspect 17: The method according to any of Aspects 1-16, further comprising: transmitting, to the network entity, a random access preamble; receiving, from the network entity, a response to the random access preamble having an uplink resource grant; transmitting, to the network entity, a payload via the uplink resource grant; and receiving, from the network entity in response to the payload, acknowledgement of contention resolution.
Aspect 18: The method of Aspect 17, wherein the random access preamble or the payload includes the indication.
Aspect 19: The method according to any of Aspects 1-16, further comprising: transmitting, to the network entity, a message including a random access preamble on a physical random access channel (PRACH) and a payload on a physical uplink shared channel (PUSCH); and receiving, from the network entity in response to the message, acknowledgement of contention resolution.
Aspect 20: The method of Aspect 19, wherein the preamble or the payload includes the indication.
Aspect 21: The method according to any of Aspects 1-20, wherein communicating with the network entity comprises communicating with the network entity via a bandwidth configured for a narrowband device.
Aspect 22: The method according to any of Aspects 1-21, wherein communicating with the network entity comprises: receiving a random access response message having an uplink resource grant dedicated to a small data transmission; and transmitting, to the network entity, a payload via the uplink resource grant.
Aspect 23: The method according to any of Aspects 1-22, wherein communicating with the network entity comprises receiving, from the network entity in response to the indication, acknowledgement of contention resolution within a response window configured for low latency communications.
Aspect 24: A method of wireless communication by a network entity, comprising: receiving, from a user equipment (UE) in a random access channel (RACH) procedure, an indication of at least one of a capability of the UE or a service for the UE; and communicating with the UE in accordance with the indication.
Aspect 25: The method of Aspect 24, wherein the indication is provided via a medium access control (MAC) control element (CE).
Aspect 26: The method of Aspect 25, wherein the MAC CE includes a bitmap associated with the capability or the service.
Aspect 27: The method according to any of Aspects 24-26, wherein the indication is provided via a MAC subheader of the MAC CE.
Aspect 28: The method of Aspect 27, wherein the MAC subheader includes a logic channel identifier (LCID) having one or more codepoints associated with the capability or the service.
Aspect 29: The method of Aspect 27, wherein: the MAC subheader includes a bit flag and a bit array; the bit flag indicates indicates whether the bit array includes the capability or the service; and the bit array includes one or more codepoints associated with the capability or the service.
Aspect 30: The method according to any of Aspects 24-29, further comprising: transmitting, to the UE, a configuration for one or more random access parameters associated with the capability or the service; and performing the RACH procedure according to the one or more random access parameters, wherein performing the RACH procedure includes receiving the indication.
Aspect 31: The method of Aspect 30, wherein the one or more random access parameters include at least one of: a power ramping step for the RACH procedure, a target received power level of preambles at the network entity, a backoff scaling factor, a response window for a random access response in the RACH procedure, a total number of RACH preambles, a maximum transmit power for a preamble, an offset of a lowest RACH transmission occasion in the frequency domain, a number of RACH transmission occasions in a slot, or a pattern in the time domain for RACH transmission occasions.
Aspect 32: The method according to any of Aspects 30 or 31, wherein the configuration includes a physical uplink shared channel resource allocation for a message to the network entity in the RACH procedure.
Aspect 33: The method according to any of Aspects 24-32, wherein the indication includes a preamble sequence value that indicates the capability or the service.
Aspect 34: The method according to any of Aspects 24-33, wherein the indication includes a demodulation reference signal sequence value that indicates the capability or the service.
Aspect 35: The method according to any of Aspects 24-34, further comprising: transmitting, to the UE, a fallback indication having an uplink resource grant; and receiving, from the UE, a payload without the indication via the uplink resource grant.
Aspect 36: The method according to any of Aspects 24-34, further comprising: transmitting, to the UE, a fallback indication having an uplink resource grant; and receiving, from the UE, a payload with the indication via the uplink resource grant.
Aspect 37: The method according to any of Aspects 24-36, wherein the capability includes at least one of a narrowband capability, a coverage enhancement capability, an enhanced mobile broadband capability, or an ultra-reliable low latency capability.
Aspect 38: The method according to any of Aspects 24-37, wherein the service includes at least one of a small data transmission, random access resource isolation for radio access network (RAN) slicing, or random access prioritization for RAN slicing.
Aspect 39: The method according to any of Aspects 24-38, wherein receiving comprises receiving the indication via a common resource pool for random access.
Aspect 40: The method according to any of Aspects 24-39, further comprising: receiving, from the UE, a random access preamble; receiving, from the network entity, a response to the random access preamble having an uplink resource grant; transmitting, to the network entity, a payload via the uplink resource grant; and receiving, from the network entity in response to the payload, acknowledgement of contention resolution.
Aspect 41: The method of Aspect 40, wherein the random access preamble or the payload includes the indication.
Aspect 42: The method according to any of Aspects 24-39, further comprising: transmitting, to the network entity, a message including a random access preamble on a physical random access channel (PRACH) and a payload on a physical uplink shared channel (PUSCH); and receiving, from the network entity in response to the message, acknowledgement of contention resolution.
Aspect 43: The method of Aspect 42, wherein the preamble or the payload includes the indication.
Aspect 44: An apparatus for wireless communication, comprising: a memory; and a processor coupled to the memory, the processor capable of being configured to: transmit, to a network entity in a random access channel (RACH) procedure, an indication of at least one of a capability of the apparatus or a service for the apparatus, and communicate with the network entity in accordance with the indication.
Aspect 45: The apparatus of Aspect 44, wherein to transmit the indication, the processor is further configured to transmit the indication via control signaling in a medium access control (MAC) layer.
Aspect 46: The apparatus of Aspect 44 or 45, wherein the indication includes a message from a control plane protocol stack.
Aspect 47: The apparatus according to any of Aspects 44-46, wherein to transmit the indication, the processor is further configured to transmit the indication in a MAC subheader of a MAC packet.
Aspect 48: The apparatus of Aspect 47, wherein the MAC subheader includes a logic channel identifier (LCID) having one or more codepoints associated with the capability or the service.
Aspect 49: The apparatus of Aspect 47 or 48, wherein the MAC packet includes a common control channel (CCCH) message.
Aspect 50: The apparatus according to any of Aspects 44-49, wherein the processor is further configured to: receive a configuration for one or more random access parameters associated with the capability or the service; and perform the RACH procedure according to the one or more random access parameters, wherein to perform the RACH procedure, the processor is further configured to transmit the indication.
Aspect 51: The apparatus according to any of Aspects 44-50, wherein the indication includes a preamble sequence value that indicates the capability or the service.
Aspect 52: The apparatus according to any of Aspects 44-51, wherein the indication includes a demodulation reference signal sequence value that indicates the capability or the service.
Aspect 53: The apparatus according to any of Aspects 44-52, wherein the capability includes at least one of a narrowband capability, a coverage enhancement capability, an enhanced mobile broadband capability, or an ultra-reliable low latency capability.
Aspect 54: An apparatus for wireless communication, comprising: a memory; and a processor coupled to the memory, the processor capable of being configured to: receive, from a user equipment (UE) in a random access channel (RACH) procedure, an indication of at least one of a capability of the UE or a service for the UE, and communicate with the UE in accordance with the indication.
Aspect 55: The apparatus of Aspect 54, wherein to receive the indication, the processor is further configured to receive the indication via control signaling in a medium access control (MAC) layer.
Aspect 56: The apparatus of Aspect 54 or 55, wherein the indication includes a message from a control plane protocol stack.
Aspect 57: The apparatus according to any of Aspects 54-56, wherein to receive the indication, the processor is further configured to receive the indication in a MAC subheader of a MAC packet.
Aspect 58: The apparatus of Aspect 57, wherein the MAC subheader includes a logic channel identifier (LCID) having one or more codepoints associated with the capability or the service.
Aspect 59: The apparatus according to any of Aspects 54-58, wherein the indication includes a preamble sequence value that indicates the capability or the service.
Aspect 60: The apparatus according to any of Aspects 54-59, wherein the capability includes at least one of a narrowband capability, a coverage enhancement capability, an enhanced mobile broadband capability, or an ultra-reliable low latency capability.
Aspect 61: A method of wireless communication by a user equipment (UE), comprising: transmitting, to a network entity in a random access channel (RACH) procedure, an indication of at least one of a capability of the UE or a service for the UE; and communicating with the network entity in accordance with the indication.
Aspect 62: The method of Aspect 61, wherein transmitting the indication comprises transmitting the indication via control signaling in a medium access control (MAC) layer.
Aspect 63: The method of Aspect 61 or 62, wherein transmitting the indication comprises transmitting the indication in a MAC subheader of a MAC packet.
Aspect 64: The method of Aspect 63, wherein the MAC subheader includes a logic channel identifier (LCID) having one or more codepoints associated with the capability or the service.
Aspect 65: The method of Aspect 63 or 64, wherein the MAC packet includes a common control channel (CCCH) message.
Aspect 66: The method according to any of Aspects 61-65, wherein the indication includes a preamble sequence value that indicates the capability or the service.
Aspect 67: The method according to any of Aspects 61-66, wherein the capability includes at least one of a narrowband capability, a coverage enhancement capability, an enhanced mobile broadband capability, or an ultra-reliable low latency capability.
Aspect 68: A method of wireless communication by a network entity, comprising: receiving, from a user equipment (UE) in a random access channel (RACH) procedure, an indication of at least one of a capability of the UE or a service for the UE; and communicating with the UE in accordance with the indication.
Aspect 69: The method of Aspect 68, wherein receiving the indication comprises receiving the indication via control signaling in a medium access control (MAC) layer.
Aspect 70: The method of Aspect 68 or 69, wherein receiving the indication comprises receiving the indication in a MAC subheader of a MAC packet.
Aspect 71: The method of Aspect 70, wherein the MAC subheader includes a logic channel identifier (LCID) having one or more codepoints associated with the capability or the service.
Aspect 72: The method according to any of Aspects 68-71, wherein the indication includes a preamble sequence value that indicates the capability or the service.
Aspect 73: The method according to any of Aspects 68-72, wherein the capability includes at least one of a narrowband capability, a coverage enhancement capability, an enhanced mobile broadband capability, or an ultra-reliable low latency capability.
Aspect 74: An apparatus, comprising: a memory comprising executable instructions; one or more processors configured to execute the executable instructions and cause the apparatus to perform a method in accordance with any of Aspects 1-43 or 61-73.
Aspect 75: An apparatus, comprising means for performing a method in accordance with any of Aspects 1-43 or 61-73.
Aspect 76: A computer-readable medium comprising executable instructions that, when executed by one or more processors of an apparatus, cause the apparatus to perform a method in accordance with any of Aspects 1-43 or 61-73.
Aspect 77: A computer program product embodied on a computer-readable storage medium comprising code for performing a method in accordance with any of Aspects 1-43 or 61-73.

The techniques described herein may be used for various wireless communication technologies, such as NR (e.g., 5G NR), 3GPP Long Term Evolution (LTE), LTE-Advanced (LTE-A), code division multiple access (CDMA), time division multiple access (TDMA), frequency division multiple access (FDMA), orthogonal frequency division multiple access (OFDMA), single-carrier frequency division multiple access (SC-FDMA), time division synchronous code division multiple access (TD-SCDMA), and other networks. The terms “network” and “system” are often used interchangeably. A CDMA network may implement a radio technology such as Universal Terrestrial Radio Access (UTRA), cdma2000, etc. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as NR (e.g. 5G RA), Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS). LTE and LTE-A are releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). NR is an emerging wireless communications technology under development.

In 3GPP, the term “cell” can refer to a coverage area of a Node B (NB) and/or a NB subsystem serving this coverage area, depending on the context in which the term is used. In NR systems, the term “cell” and BS, next generation NodeB (gNB or gNodeB), access point (AP), distributed unit (DU), carrier, or transmission reception point (TRP) may be used interchangeably. A BS may provide communication coverage for a macro cell, a pico cell, a femto cell, and/or other types of cells. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having an association with the femto cell (e.g., UEs in a Closed Subscriber Group (CSG), UEs for users in the home, etc.). A BS for a macro cell may be referred to as a macro BS. A BS for a pico cell may be referred to as a pico BS. A BS for a femto cell may be referred to as a femto BS or a home BS.

A UE may also be referred to as a mobile station, a terminal, an access terminal, a subscriber unit, a station, a Customer Premises Equipment (CPE), a cellular phone, a smart phone, a personal digital assistant (PDA), a wireless modem, a wireless communication device, a handheld device, a laptop computer, a cordless phone, a wireless local loop (WLL) station, a tablet computer, a camera, a gaming device, a netbook, a smartbook, an ultrabook, an appliance, a medical device or medical equipment, a biometric sensor/device, a wearable device such as a smart watch, smart clothing, smart glasses, a smart wrist band, smart jewelry (e.g., a smart ring, a smart bracelet, etc.), an entertainment device (e.g., a music device, a video device, a satellite radio, etc.), a vehicular component or sensor, a smart meter/sensor, industrial manufacturing equipment, a global positioning system device, or any other suitable device that is configured to communicate via a wireless or wired medium. Some UEs may be considered machine-type communication (MTC) devices or evolved MTC (eMTC) devices. MTC and eMTC UEs include, for example, robots, drones, remote devices, sensors, meters, monitors, location tags, etc., that may communicate with a BS, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IOT) devices, which may be narrowband IoT (NB-IOT) devices.

In some examples, access to the air interface may be scheduled. A scheduling entity (e.g., a BS) allocates resources for communication among some or all devices and equipment within its service area or cell. The scheduling entity may be responsible for scheduling, assigning, reconfiguring, and releasing resources for one or more subordinate entities. That is, for scheduled communication, subordinate entities utilize resources allocated by the scheduling entity. Base stations are not the only entities that may function as a scheduling entity. In some examples, a UE may function as a scheduling entity and may schedule resources for one or more subordinate entities (e.g., one or more other UEs), and the other UEs may utilize the resources scheduled by the UE for wireless communication. In some examples, a UE may function as a scheduling entity in a peer-to-peer (P2P) network, and/or in a mesh network. In a mesh network example, UEs may communicate directly with one another in addition to communicating with a scheduling entity.

The methods disclosed herein comprise one or more steps or actions for achieving the methods. The method steps and/or actions may be interchanged with one another. In other words, unless a specific order of steps or actions is specified, the order and/or use of specific steps and/or actions may be modified.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The previous description is provided to enable any person skilled in the art to practice the various aspects described herein. Various modifications to these aspects will be readily apparent to those skilled in the art, and the generic principles defined herein may be applied to other aspects. Reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

The various operations of methods described above may be performed by any suitable means capable of performing the corresponding functions. The means may include various hardware and/or software component(s) and/or module(s), including, but not limited to a circuit, a digital signal processor (DSP), an application specific integrated circuit (ASIC), or a processor (e.g., a general purpose or specifically programmed processor). Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a graphics processing unit (GPU), a DSP, an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user terminal (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, phase change memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above can also be considered as examples of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein, for example, instructions for performing the operations described herein and illustrated in FIG. 6 and/or FIG. 7.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above.

1. An apparatus for wireless communication, comprising:
a memory; and
a processor coupled to the memory, the processor capable of being configured to:
transmit, to a network entity in a random access channel (RACH) procedure, an indication of at least one of a capability of the apparatus or a service for the apparatus, and
communicate with the network entity in accordance with the indication.

2. The apparatus of claim 1, wherein to transmit the indication, the processor is further configured to transmit the indication via control signaling in a medium access control (MAC) layer.

3. The apparatus of claim 1, wherein the indication includes a message from a control plane protocol stack.

4. The apparatus of claim 1, wherein to transmit the indication, the processor is further configured to transmit the indication in a MAC subheader of a MAC packet.

5. The apparatus of claim 4, wherein the MAC subheader includes a logic channel identifier (LCID) having one or more codepoints associated with the capability or the service.

6. The apparatus of claim 4, wherein the MAC packet includes a common control channel (CCCH) message.

7. The apparatus of claim 1, wherein the processor is further configured to:
receive a configuration for one or more random access parameters associated with the capability or the service; and
perform the RACH procedure according to the one or more random access parameters, wherein to perform the RACH procedure, the processor is further configured to transmit the indication.

8. The apparatus of claim 1, wherein the indication includes a preamble sequence value that indicates the capability or the service.

9. The apparatus of claim 1, wherein the indication includes a demodulation reference signal sequence value that indicates the capability or the service.

10. The apparatus of claim 1, wherein the capability includes at least one of a narrowband capability, a coverage enhancement capability, an enhanced mobile broadband capability, or an ultra-reliable low latency capability.

11. An apparatus for wireless communication, comprising:
a memory; and
a processor coupled to the memory, the processor capable of being configured to:
receive, from a user equipment (UE) in a random access channel (RACH) procedure, an indication of at least one of a capability of the UE or a service for the UE, and
communicate with the UE in accordance with the indication.

12. The apparatus of claim 11, wherein to receive the indication, the processor is further configured to receive the indication via control signaling in a medium access control (MAC) layer.

13. The apparatus of claim 11, wherein the indication includes a message from a control plane protocol stack.

14. The apparatus of claim 11, wherein to receive the indication, the processor is further configured to receive the indication in a MAC subheader of a MAC packet.

15. The apparatus of claim 14, wherein the MAC subheader includes a logic channel identifier (LCID) having one or more codepoints associated with the capability or the service.

16. The apparatus of claim 11, wherein the indication includes a preamble sequence value that indicates the capability or the service.

17. The apparatus of claim 11, wherein the capability includes at least one of a narrowband capability, a coverage enhancement capability, an enhanced mobile broadband capability, or an ultra-reliable low latency capability.

18. A method of wireless communication by a user equipment (UE), comprising:
transmitting, to a network entity in a random access channel (RACH) procedure, an indication of at least one of a capability of the UE or a service for the UE; and
communicating with the network entity in accordance with the indication.

19. The method of claim 18, wherein transmitting the indication comprises transmitting the indication via control signaling in a medium access control (MAC) layer.

20. The method of claim 18, wherein transmitting the indication comprises transmitting the indication in a MAC subheader of a MAC packet.

21. The method of claim 20, wherein the MAC subheader includes a logic channel identifier (LCID) having one or more codepoints associated with the capability or the service.

22. The method of claim 20, wherein the MAC packet includes a common control channel (CCCH) message.

23. The method of claim 18, wherein the indication includes a preamble sequence value that indicates the capability or the service.

24. The method of claim 18, wherein the capability includes at least one of a narrowband capability, a coverage enhancement capability, an enhanced mobile broadband capability, or an ultra-reliable low latency capability.

25. A method of wireless communication by a network entity, comprising:
receiving, from a user equipment (UE) in a random access channel (RACH) procedure, an indication of at least one of a capability of the UE or a service for the UE; and
communicating with the UE in accordance with the indication.

26. The method of claim 25, wherein receiving the indication comprises receiving the indication via control signaling in a medium access control (MAC) layer.

27. The method of claim 25, wherein receiving the indication comprises receiving the indication in a MAC subheader of a MAC packet.

28. The method of claim 27, wherein the MAC subheader includes a logic channel identifier (LCID) having one or more codepoints associated with the capability or the service.

29. The method of claim 25, wherein the indication includes a preamble sequence value that indicates the capability or the service.

30. The method of claim 25, wherein the capability includes at least one of a narrowband capability, a coverage enhancement capability, an enhanced mobile broadband capability, or an ultra-reliable low latency capability.
